(19) United States
(12) Patent Application Publication
(10) Pub. No.: US 2024/0178504 A1
(43) Pub. Date: May 30, 2024

(54) SELF-ALIGNMENT SYSTEMS FOR STACKABLE BATTERIES

(71) Applicant: Ford Global Technologies, LLC, Dearborn, MI (US)

(72) Inventors: Ireneusz Trybula, South Lyon, MI (US); Raj Sohmshetty, Canton, MI (US); Sam Hoff, Hazel Park, MI (US)

(73) Assignee: Ford Global Technologies, LLC, Dearborn, MI (US)

(21) Appl. No.: 18/060,490

(22) Filed: Nov. 30, 2022

(51) Int. Cl. H01M 50/289; H01M 10/42; H01M 10/46; H01M 50/264

(52) U.S. Cl. CPC H01M 50/289; H01M 10/425; H01M 10/46; H01M 50/264

(57) ABSTRACT

Self-alignment systems for stackable batteries are disclosed herein. An example apparatus can include a lid and a container that is configured to receive and retain a battery, the lid and container being configured to enclose the battery, a first alignment mechanism positioned on a surface of the lid or the container, the first alignment mechanism having a first locking member that engages with an alignment receiver of another stackable battery assembly that is stacked with the stackable battery assembly, and an electrical interface in electrical communication with the battery, the electrical interface allowing the battery to be charged or discharged by an associated device.

### BACKGROUND

Swappable and stackable batteries are being deployed in a wide variety of applications. Some swappable and stackable batteries are proprietary to OEM (Original Equipment Manufacturers such as FORD). Batteries can charge other connected batteries and the stack of batteries may be added to or subtracted from. With the high cos Some swappable and stackable batteries t of an individual battery and related systems it can be assumed that owners would want to secure these batteries. It is envisioned that robots and other autonomous devices will be configured to swap their own batteries autonomously or manually.

In many instances, current configurations require a high degree of precision to correctly align the robot and battery receptacle. For example, if an autonomous robotic platform is intended to swap its own battery the precision required in the x and y planes is very tight. The connector of a battery is not able to reposition itself within the battery to account for a misalignment. Also, docking a battery to a battery station requires precise timing for the opening of the locks so that docking may occur.

### BRIEF DESCRIPTION OF THE DRAWINGS

A detailed description is set forth regarding the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a perspective view of an example system of the present disclosure.

FIG. 2 is a perspective view of an example stackable battery assembly.

FIG. 3A is a perspective view of a container of an example stackable battery assembly.

FIG. 3B is a schematic diagram of an example controller and related battery components.

FIG. 4 is a perspective view of an example battery kiosk.

FIG. 5 is a schematically illustrates example robots picking up and dropping off a stackable battery at a kiosk.

### DETAILED DESCRIPTION

### Overview

This disclosure pertains to self-locking alignment systems and methods for stackable batteries. An example system involves using a combination of mechanical and electrical actuation for locking. A locking mechanism that can be latched mechanically, as well as electronically, can provide the necessary smart security features while still being able to be plugged in, secured, and charged while the battery is too low on power to actuate the electronic locks. There may be one lock per alignment mechanism, or one lock per pair or group of alignment mechanisms. By incorporating physical alignment features, it is possible to guide a robot or autonomous device to subtly move the receptacle/second battery to ensure a successful battery pickup or drop-off. The systems and methods herein provide for 180-degree rotational symmetry. Batteries can be locked and unlocked electronically and do not require special timing of lock actuation to place a battery onto the stack. Some embodiments may include two locking members, for instance, one per alignment member, but some embodiments can utilize a single locking member or mechanism. In some embodiments, the locking member locks automatically, without user input, when one battery assembly is stacked on another battery assembly.

### Illustrative Embodiments

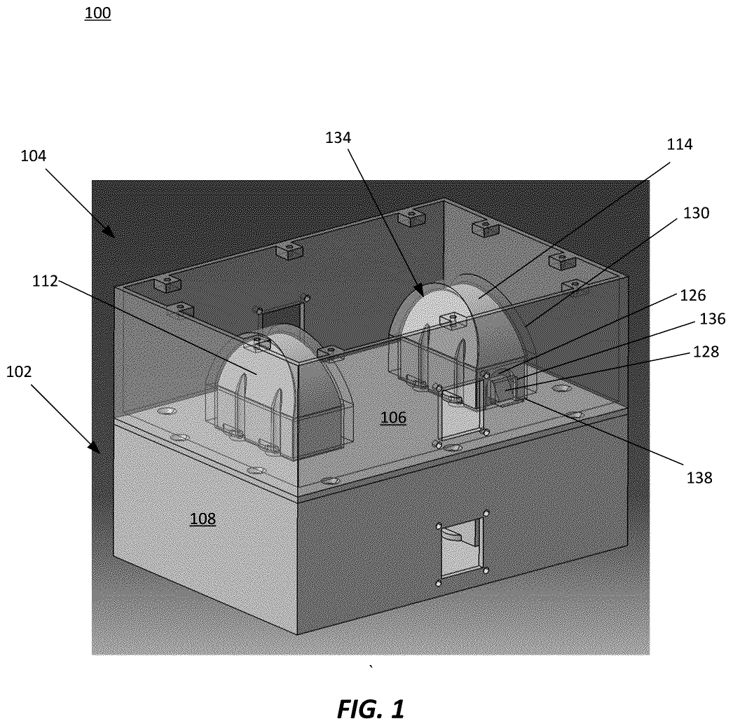

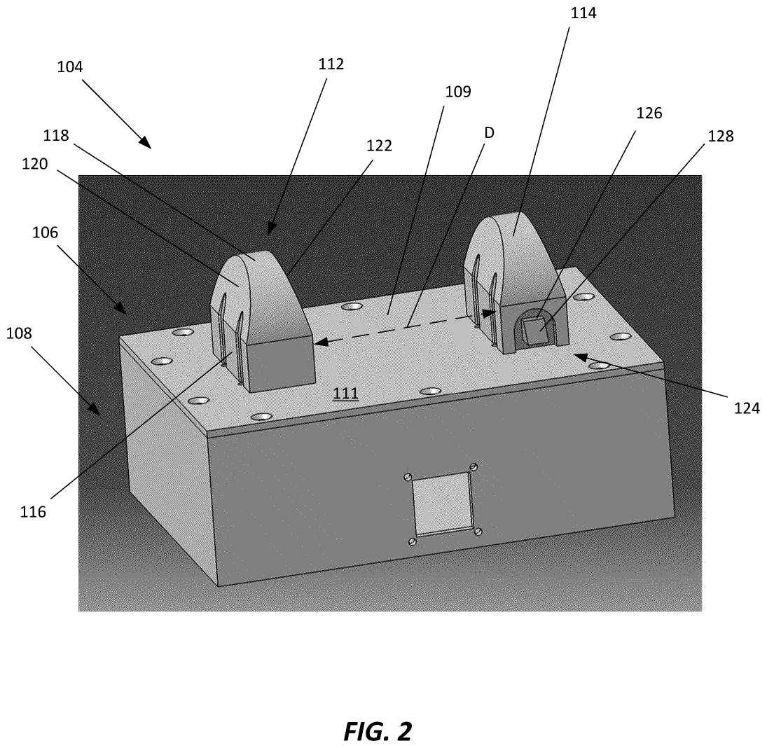

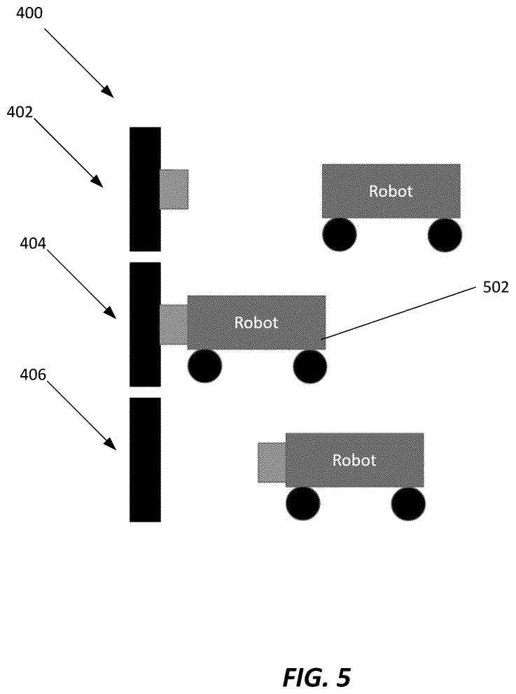

Turning now to the drawings, FIG. 1 depicts a portion of a system 100 that includes a first stackable battery assembly 102 and a second stackable battery assembly 104. Additional stackable battery assemblies can be included in some embodiments (see, for example, FIG. 5). For explanatory purposes, only a portion of the second stackable battery assembly 104 is illustrated, which portion is shown partially transparent for illustrative purposes. In general, the first and second stackable battery assemblies are identical in structure and construction to one another. The following description of FIG. 2, describes additional details regarding the first stackable battery assembly 102, which are also relevant to the second stackable battery assembly 104. In order to provide illustrate features of the first stackable battery assembly 102, a lid of the second stackable battery assembly 104 has been omitted.

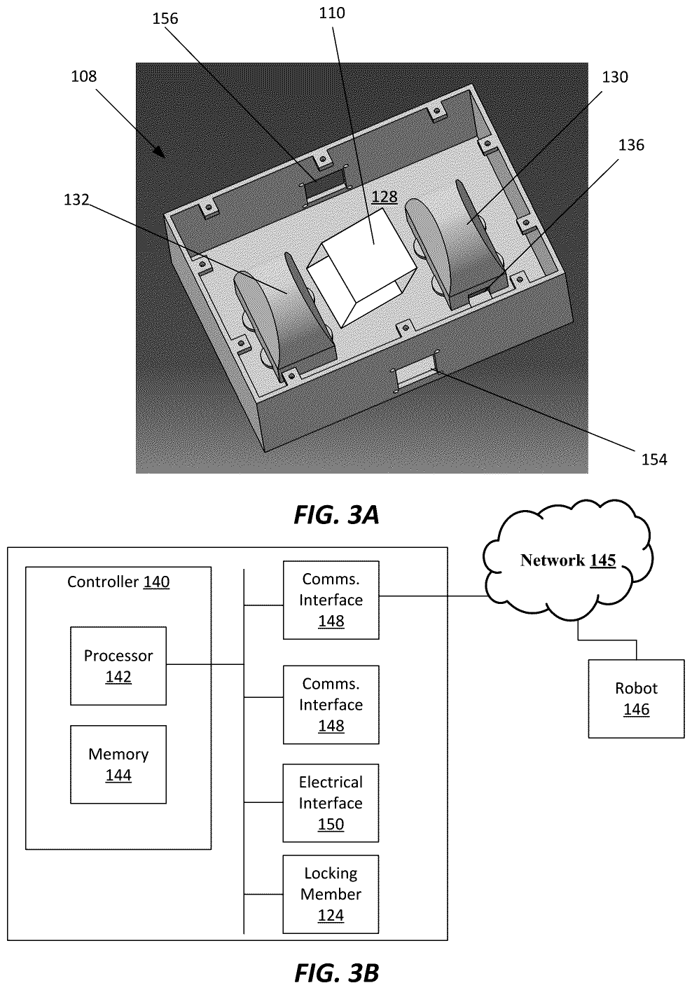

Referring now to FIGS. 2 and 3, the first stackable battery assembly 102 includes a lid 106, a container 108, and a battery 110. The lid 106 includes a plate 109 with an upper surface 111. The lid 106 includes a first alignment mechanism 112 and a second alignment mechanism 114. The first alignment mechanism 112 and the second alignment mechanism 114 can be spaced apart from one another at a distance D. The size of the distance D can vary according to design requirements. The first alignment mechanism 112 and the second alignment mechanism 114 can extend orthogonally from the upper surface 111 of the plate 109 in one example. However, as noted above, the first alignment mechanism 112 and the second alignment mechanism 114 can extend from any surface of the lid 106 or container 108.

In one example, the first alignment mechanism 112 can include a polygonal base 116 with an arcuate dome 118. The arcuate dome 118 can have tapered sides 120 and 122. Both the arcuate dome and tapered sides provide for alignment of the battery with its intended receptor, such as another battery of receptacle of a device, such as a robot. It will be understood that the shape described is not intended to be limiting and the shape alignment mechanisms can vary according to design parameters.

Each of the alignment mechanisms can include a locking member, such as locking member 124. The locking member 124 can include a plunger 126 that has a tapered end 128 of the latch. The latch may be spring loaded to allow the latch to recess recoil slightly when on assembly is stack on another assembly. When the latch returns to its biased position, which may be the result of a spring biasing the latch out, the latch edge catches the assembly of the strike plate of the other assembly.

The plunger 126 can be driven manually or by a mechanism such as a motor or solenoid. The mechanism used to translate the plunger between locked (extended) and unlocked (retracted) positions can be housed within the polygonal base 116. As noted throughout, the second alignment mechanism 114 can also include a locking member that is identical to the locking member 124 of the first alignment mechanism 112. While one locking member 124 is shown in FIG. 2, a second locking member may be provided on the first alignment mechanism 112, either on the same side of the polygonal base 116 as polygonal base 114, or on the opposite side of the polygonal base 116, such that the two locking members are facing in opposite directions.

Referring now to FIG. 3A the container 108 can include four sidewalls and a lower plate 111. The lid 106, not shown, can be coupled with the container to form an enclosure around the battery 110. The container 108 can include a first alignment receiver 130 and a second alignment receiver 132. Again, the first alignment receiver 130 and the second alignment receiver 132 are substantially identical to one another.

The first alignment receiver 130 and the second alignment receiver 132 are substantially identical in construction related to one another. Thus, descriptions of the first alignment receiver 130 are equally applicable to the second alignment receiver 132. The first alignment receiver 130, in general is a negative or female cavity that is shaped to correspond with the first alignment mechanism 112. That is, the first alignment mechanism 112 is configured to nest or mate within a cavity as best illustrated in FIG. 1.

For example, as illustrated in FIG. 1, the first alignment receiver 130 forms a cavity 134 that is a negative of the first alignment mechanism 112. The first alignment receiver 130 includes a strike plate 136 that located on the first alignment receiver 130 at a position that ensures that the strike plate 136 aligns with the plunger 126 of the locking member 124. The strike plate 136 includes an aperture, which in some instances is square in shape.

Referring briefly to FIG. 1, when the second stackable battery assembly 104 is placed on top of the first stackable battery assembly 102, a lower edge 138 of the first alignment receiver 130 contacts the tapered end 128 of the plunger 126, causing the plunger 126 to retract, at least partially into the polygonal base 116 of the first alignment receiver 130. When the plunger 126 aligns with the strike plate 136, the plunger 126 extends to the locked position securing the second stackable battery assembly 104 and the first stackable battery assembly 102. That is, the plunger 126 extends into the strike plate 136 thereby preventing the second stackable battery assembly 104 from disassociating from the first stackable battery assembly 102.

The placement, spacing and configuration of the first alignment receiver 130 and the second alignment receiver 132 substantially corresponds to the placement, spacing and configuration of the first alignment mechanism 112 and the second alignment mechanism 114. This ensures that when the second stackable battery assembly 104 is placed on to the first stackable battery assembly that the first alignment mechanism 112 and the second alignment mechanism 114 nest inside the first alignment receiver 130 and the second alignment receiver 132, respectively, of the first battery assembly 102.

In some examples, the battery 110 can be disposed between the first alignment receiver 130 and the second alignment receiver 132. Any number of batteries can be located inside the container 108, and may be of any suitable shape or configuration.

Also, the container 108 can include a pair of docking interfaces 154 and 156 located on opposing surfaces of the container 108. A robot can insert a lever through the docking interfaces 154 and 156 in order to remove or replace the first stackable battery assembly 102, such as into a stackable battery assembly kiosk (see FIG. 5 for an example stackable battery assembly kiosk).

Referring to FIG. 3B, the first stackable battery assembly 102 can comprise a controller 140 that includes a processor 142 and memory 144. The processor 142 can execute instructions stored in memory 144 to control the locking member 124 of the first alignment member, when the locking member 124 may include a motor, solenoid, or equivalent device for securing one battery assembly to another when stacked. In some instances, the controller 140 is responsive to signals received from, for example, a robot 146. While a robot can communicate with the controller 140, other devices such as a mobile device can also be used. The controller 140 can include a communications interface 148 that is used to transmit and/or receive signals over a long- or short-range wireless signals over a network 145 to the robot 146 and/or mobile device.

In one example, the robot 146 can transmit a signal to the controller 140 that will cause the locking member 124 to lock or unlock (depending on context) the battery assembly 102. For example, when the robot 146 approaches a stack of stackable battery assemblies, the robot 146 can transmit a signal to the controller 140 requesting one of the stackable battery assembly to unlock itself from an adjacently stacked battery. For example, the plunger may be retracted into an unlocked position, which allows first stackable battery assembly 102 to be removed from the second stackable battery assembly 104.

The first stackable battery assembly 102 can also comprise an electrical interface 152 that can be positioned anywhere on any surface of the first stackable battery assembly 102. The electrical interface 152 can mate with a corresponding electrical interface of another stackable battery assembly (stackable battery assemblies are in a stacked configuration). The electrical interface 150 can interface with a corresponding electrical interface on the robot 146, allowing the robot 146 to receive electrical power from the battery 110 of the first stackable battery assembly 102.

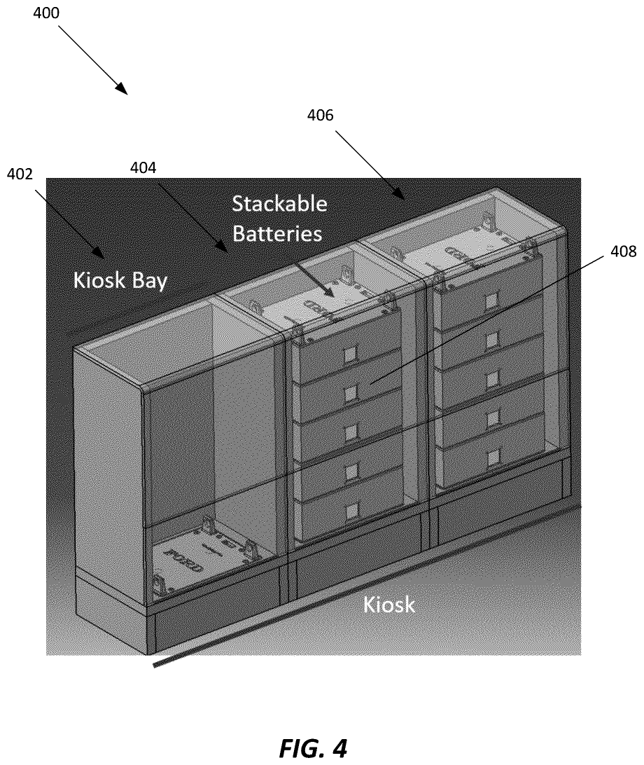

FIGS. 4 and 5 collectively illustrate an example battery kiosk 400 that includes a plurality of bays 402-406, as well as robots 502 interacting with the kiosk 400. The bays are arranged in a side-by-side manner in some instances. Each bay is a vertical stack of stackable battery assemblies. In this example, the stackable battery assemblies are vertically stacked, however, the stackable battery assemblies can be stacked in other configurations. For example, the stackable battery assemblies can be horizontally oriented. In a vertical orientation, a robot or user would need to remove batteries in a top-down manner.

Bay 402 only includes a single battery assembly, which allows for the receipt of stackable battery assemblies that require charging. Also, the bay 402 can function as a staging area and receive batteries temporarily. For example, if a robot 502 desired to obtain a stackable battery assembly 408 located within the bay 404, the robot 502 could remove stackable battery assemblies above the stackable battery assembly 408 (if any). These removed stackable battery assemblies can be temporarily placed, by the robot 502 in the bay 402 and returned to the bay 404 (if desired).

Implementations of the systems, apparatuses, devices and methods disclosed herein may comprise or utilize a special purpose or general-purpose computer including computer hardware, such as, for example, one or more processors and system memory, as discussed herein. Computer-executable instructions comprise, for example, instructions and data which, when executed at a processor, cause a general-purpose computer, special purpose computer, or special purpose processing device to perform a certain function or group of functions. An implementation of the devices, systems and methods disclosed herein may communicate over a computer network. A “network” is defined as one or more data links that enable the transport of electronic data between computer systems and/or modules and/or other electronic devices.

Although the subject matter has been described in language specific to structural features and/or methodological acts, it is to be understood that the subject matter defined in the appended claims may not necessarily be limited to the described features or acts described above. Rather, the described features and acts are disclosed as example forms of implementing the claims.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “mechanically connected,” etc., are used interchangeably herein to generally refer to the condition of being mechanically/physically connected. The terms “couple” and “coupling” are also used in a non-mechanical/physical context that refers to absorption of microwave energy by a material. It is further noted that various figures (including component diagrams) shown and discussed herein are for illustrative purpose only, and are not drawn to scale. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing and/or other any other types of manufacturing. For example, some manufacturing processes include three-dimensional (3D) printing, laser cutting, computer numerical control (CNC) routing, milling, pressing, stamping, vacuum forming, hydroforming, injection molding, lithography and/or others.

Any and/or all elements, as disclosed herein, can include, whether partially and/or fully, a solid, including a metal, a mineral, a ceramic, an amorphous solid, such as glass, a glass ceramic, an organic solid, such as wood and/or a polymer, such as rubber, a composite material, a semiconductor, a nano-material, a biomaterial and/or any combinations thereof. Any and/or all elements, as disclosed herein, can include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, non-transparency, luminescence, anti-reflection and/or holographic, a photo-sensitive coating, an electronic and/or thermal property coating, such as for passivity, insulation, resistance or conduction, a magnetic coating, a water-resistant and/or waterproof coating, a scent coating and/or any combinations thereof.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A stackable battery assembly, comprising:
a lid;
a container that is configured to receive and retain a battery, the lid and container being configured to enclose the battery;
a first alignment mechanism positioned on a surface of the lid or the container, the first alignment mechanism comprising a first locking member that engages with an alignment receiver of another stackable battery assembly that is stacked with the stackable battery assembly; and
an electrical interface in electrical communication with the battery, the electrical interface allowing the battery to be charged or discharged by an associated device.

2. The stackable battery assembly according to claim 1, wherein the first alignment mechanism includes a polygonal base with an arcuate dome.

3. The stackable battery assembly according to claim 2, wherein the arcuate dome comprises tapered sides.

4. The stackable battery assembly according to claim 1, further comprising a second alignment mechanism that is identical to the first alignment mechanism, wherein the first alignment mechanism and the second alignment mechanism are spaced apart from one another at a distance.

5. The stackable battery assembly according to claim 4, wherein the second alignment mechanism comprises a second locking member.

6. The stackable battery assembly according to claim 5, wherein the first locking member and the second locking member are each electrically operated.

7. The stackable battery assembly according to claim 5, wherein the first locking member and the second locking member extend in opposite directions relative to one another.

8. The stackable battery assembly according to claim 7, further comprising a controller having a processor and memory, the processor executing instructions stored in the memory to:
cause the first locking member and the second locking member to extend when a locking signal is received; and
cause the first locking member and the second locking member to retract when an unlocking signal is received.

9. The stackable battery assembly according to claim 1, wherein the alignment receiver of another stackable battery assembly comprises a strike plate that is aligned with the first locking member, wherein when the first locking member is extended into the strike plate, the stackable battery assembly cannot be disassociated with the another battery assembly.

10. A system, comprising:
a first stackable battery assembly and a second stackable battery assembly, wherein each of the first stackable battery assembly and the second stackable battery assembly comprise:
a lid; and
a container that is configured to receive and retain a battery, the lid and container being configured to enclose the battery, the container comprising an alignment receiver;
a first alignment mechanism positioned on a surface of the lid or the container, the first alignment mechanism comprising a first locking member; and
an electrical interface in electrical communication with the battery, the electrical interface allowing the battery to be charged or discharged by an associated device,
wherein the first stackable battery assembly is stacked on top of the second stackable battery assembly in such a way that the first alignment mechanism is nested inside an alignment receiver of the second stackable battery assembly, the first locking member being extended to lock the first alignment mechanism with the alignment receiver.

11. The system according to claim 10, wherein the first alignment mechanism includes a polygonal base with an arcuate dome.

12. The system according to claim 11, wherein the arcuate dome comprises tapered sides.

13. The system according to claim 10, further comprising a second alignment mechanism that is identical to the first alignment mechanism, wherein the first alignment mechanism and the second alignment mechanism are spaced apart from one another at a distance.

14. The system according to claim 13, wherein the second alignment mechanism comprises a second locking member.

15. The system according to claim 14, wherein the first locking member and the second locking member are each electrically operated.

16. The system according to claim 15, wherein the first locking member and the second locking member extend in opposite directions relative to one another.

17. The system according to claim 16, wherein the alignment receiver comprises a strike plate that is aligned with the first locking member, wherein when the first locking member is extended into the strike plate, the first stackable battery assembly cannot be disassociated with the second stackable battery assembly.

18. The system according to claim 17, wherein each of the first stackable battery assembly and the second stackable battery assembly comprise a controller having a processor and memory, the processor executing instructions stored in the memory to:
cause the first locking member and the second locking member to extend when a locking signal is received; and
cause the first locking member and the second locking member to retract when an unlocking signal is received.

19. A stackable battery assembly, comprising:
a lid having a pair of alignment mechanisms positioned on an upper surface of the, each of the pair of alignment mechanisms comprising a locking member; and
a container that is configured to receive and retain a battery, the lid and container being configured to enclose the battery, a pair of alignment receivers forming cavities that are shaped identically to the pair of alignment mechanisms, the pair of alignment receivers being aligned with the pair of alignment mechanisms;
an electrical interface in electrical communication with the battery, the electrical interface allowing the battery to be charged or discharged by an associated device; and
wherein the pair of alignment receivers receive a pair of alignment mechanisms of another stackable battery assembly upon which the stackable battery assembly is stacked.
